(19) United States
(12) Patent Application Publication
(10) Pub. No.: US 2012/0222659 A1
(43) Pub. Date: Sep. 6, 2012

(54) METHODS AND SYSTEMS FOR AN ENGINE

(75) Inventors: Sachin Shivajirao Kulkarni, Bangalore (IN); Sebastian Walter Freund, Garching (DE); Jassin Marcel Fritz, Garching (DE); Georgios Bikas, Garching (DE); James Henry Yager, Lawrence Park, PA (US); Shashi Kiran, Lawrence Park, PA (US)

(73) Assignee: GENERAL ELECTRIC COMPANY, Schenectady, NY (US)

(21) Appl. No.: 13/039,957

(22) Filed: Mar. 3, 2011

(51) Int. Cl. F02M 25/07

(52) U.S. Cl. 123/568.11

(57) ABSTRACT

Various methods and systems are provided for operating an exhaust gas recirculation engine having a plurality of exhaust gas donor cylinders and a plurality of non-donor cylinders. One example method includes firing each of the engine cylinders in a cylinder firing order, including firing at least one of the non-donor cylinders between every donor cylinder firing of the engine cycle.

### FIELD

The subject matter disclosed herein relates to methods and systems for an exhaust gas recirculation engine having a plurality of exhaust gas donor cylinders whose exhaust gas is recirculated to the intake and a plurality of non-donor cylinders whose exhaust gas is discharged.

### BACKGROUND

Engines may utilize recirculation of exhaust gas from an engine exhaust system to an engine intake system, a process referred to as exhaust gas recirculation (EGR), to reduce regulated emissions. In some examples, one or more cylinders are dedicated to generating exhaust gas for EGR. Such cylinders may be referred to as “donor cylinders.” The number of donor cylinders and position in a firing order during an engine cycle of the engine may affect a distribution of EGR across the cylinders. For example, when the distribution of EGR is uneven, increased emissions, engine noise and vibration and increased torque imbalance between cylinders may occur.

### BRIEF DESCRIPTION

In one embodiment, a method of operating an exhaust gas recirculation engine having a plurality of exhaust gas donor cylinders and a plurality of non-donor cylinders includes firing each of the engine cylinders in a cylinder firing order, including firing at least one of the non-donor cylinders between every donor cylinder firing of the engine cycle.

In such an embodiment, the firing of donor cylinders may be spaced such that the firing of the donor cylinders occurs with even spacing. For example, one non-donor cylinder may be fired between every donor cylinder firing (e.g., one donor cylinder is fired, one non-donor cylinder is fired, one donor cylinder is fired, one non-donor cylinder is fired, etc.). In this manner, fluctuation of the fraction of exhaust gas in the intake air over the engine cycle may be reduced thereby reducing emissions, engine noise and vibration, for example.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a schematic diagram of an example embodiment of a rail vehicle with an engine according to an embodiment of the invention.

FIG. 2 shows a schematic diagram of an example embodiment of an engine with a plurality of donor cylinders and a plurality of non-donor cylinders.

FIGS. 3-5 show schematic diagrams illustrating donor cylinder configurations for an engine with a plurality of donor cylinders and a plurality of non-donor cylinders.

FIG. 6 shows a high level flow chart illustrating a method for operating an engine with a plurality of donor cylinders and a plurality of non-donor cylinders.

### DETAILED DESCRIPTION

The following description relates to various embodiments of methods and systems for an engine with a plurality of donor cylinders and a plurality of non-donor cylinders. In one example embodiment, a method includes firing at least one of the non-donor cylinders between any and every two donor cylinder firings in the cylinder firing order. For example, a donor cylinder firing may be followed by two non-donor cylinder firings that are followed by another donor cylinder firing. Further, in some embodiments, two or more donor cylinders may be contiguous (e.g., positioned immediately adjacent one another) in an engine bank. As such, engine noise and vibration may be reduced and a size of an exhaust manifold which routes exhaust gas from the donor cylinders to an intake manifold of the engine may be reduced.

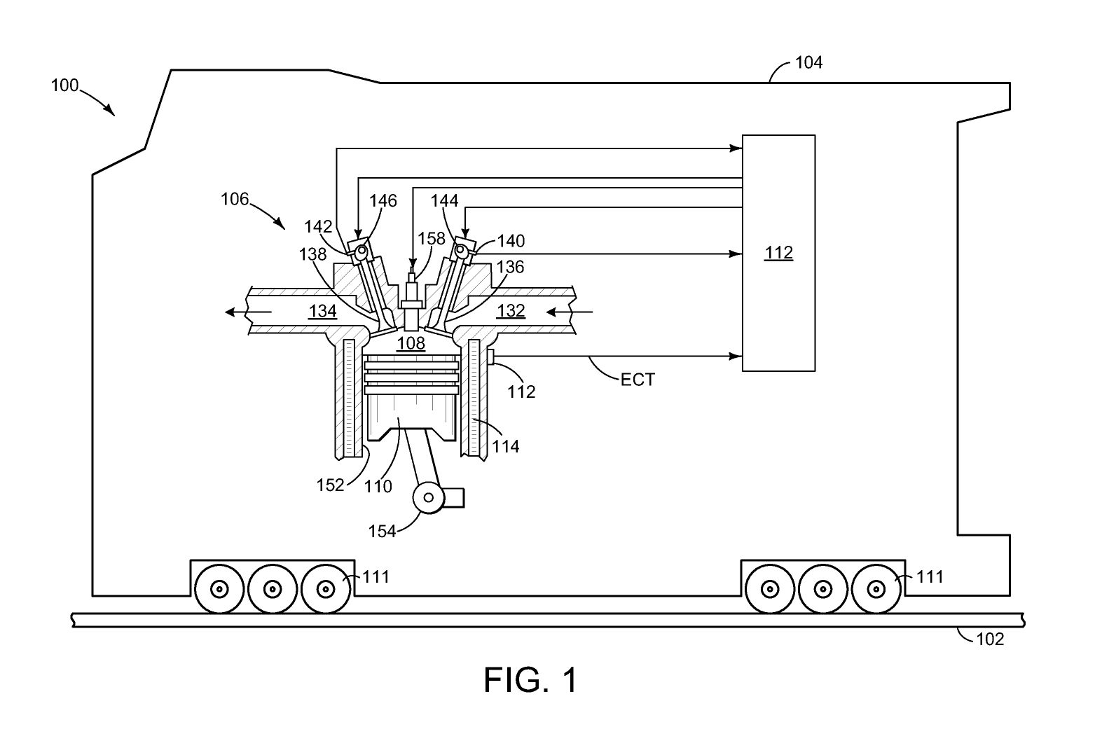

In some embodiments, the engine is configured to be positioned in a vehicle, such as a rail vehicle. For example, FIG. 1 shows a schematic diagram of an example embodiment of a vehicle system 100 (e.g., a locomotive system), herein depicted as a rail vehicle 104, configured to run on a rail 102 via a plurality of wheels 111. The rail vehicle 104 includes an internal combustion engine 106. In other non-limiting embodiments, engine 106 may be a stationary engine, such as in a power-plant application, or an engine in a ship propulsion system or an off-highway vehicle propulsion system.

FIG. 1 depicts an example embodiment of a combustion chamber, or cylinder, of a multi-cylinder internal combustion engine 106. The engine 106 may be controlled at least partially by a control system including controller 112. The cylinder (i.e., combustion chamber) 108 of engine 106 may include combustion chamber walls 152 with a piston 110 positioned therein. The piston 110 may be coupled to a crankshaft 154 so that reciprocating motion of the piston is translated into rotational motion of the crankshaft. In some embodiments, the engine 106 may be a four-stroke engine in which each of the cylinders fires in a firing order during two revolutions of the crankshaft 154. In other embodiments, the engine 106 may be a two-stroke engine in which each of the cylinders fires in a firing order during one revolution of the crankshaft 154.

The cylinder 108 receives intake air for combustion from an intake passage 132. The intake passage 132 receives ambient air from an air filter (not shown) that filters air from outside of the rail vehicle 104. The intake air passage 132 may communicate with other cylinders of engine 106 in addition to cylinder 108, for example.

Exhaust gas resulting from combustion in the engine 106 is supplied to an exhaust passage 134. Exhaust gas flows through the exhaust passage 134, to a turbocharger (not shown in FIG. 1) and out of an exhaust stack (not shown) of the rail vehicle 104. The exhaust passage 134 can further receive exhaust gases from other cylinders of engine 106 in addition to cylinder 108, for example. Further, an exhaust gas treatment system (not shown) including one or more exhaust gas treatment devices may be coupled to the exhaust passage 134. For example, the exhaust gas treatment system may include a selective catalytic reduction (SCR) system, a diesel oxidation catalyst (DOC), a diesel particulate filter (DPF), various other emission control devices, or combinations thereof.

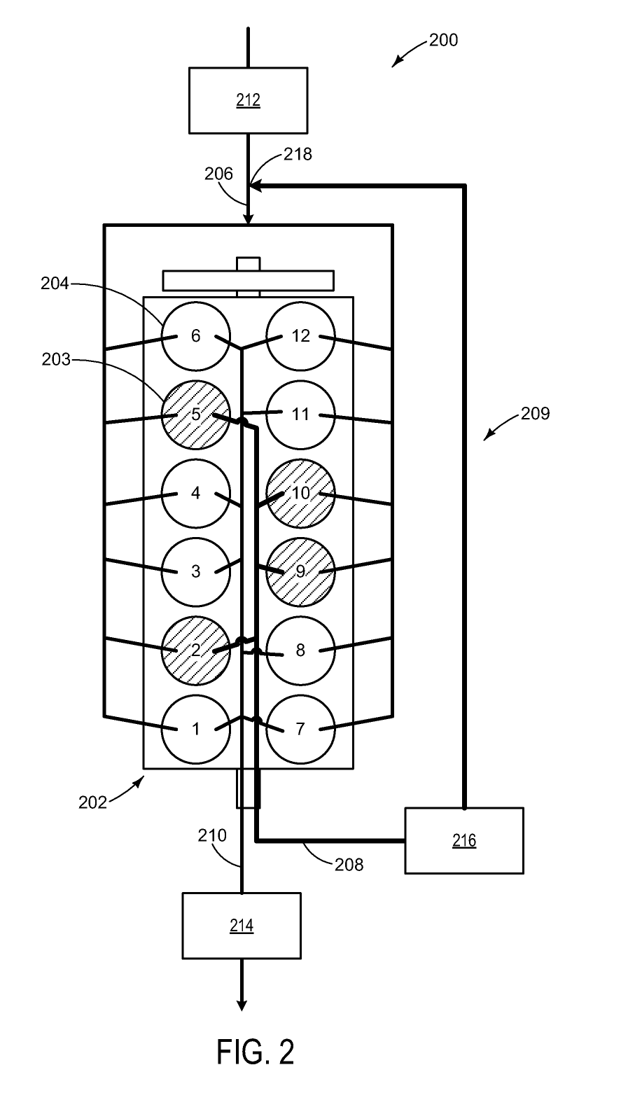

In some embodiments, as will be described in greater detail below with reference to FIG. 2, the vehicle system may include more than one exhaust passage. For example, one group of cylinders may be coupled to a first exhaust manifold and another group of cylinders may be coupled to a second exhaust manifold. In this way, one of the groups of cylinders may be comprised exclusively of donor cylinders which recirculate exhaust gas to the intake passage 132.

Continuing with FIG. 1, each cylinder of the engine 106 may include one or more intake valves and one or more exhaust valves. For example, the cylinder 108 is shown including at least one intake poppet valve 136 and at least one exhaust poppet valve 138 located in an upper region of cylinder 108. In some embodiments, each cylinder of the engine 106, including cylinder 108, may include at least two intake poppet valves and at least two exhaust poppet valves located at the cylinder head.

The intake valve 136 may be controlled by the controller 112 via actuator 144. Similarly, the exhaust valve 138 may be controlled by the controller 112 via actuator 146. During some conditions, the controller 112 may vary the signals provided to actuators 144 and 146 to control the opening and closing of the respective intake and exhaust valves. The position of intake valve 136 and exhaust valve 138 may be determined by respective valve position sensors 140 and 142, respectively. The valve actuators may be of the electric valve actuation type or cam actuation type, or a combination thereof, for example.

The intake and exhaust valve timing may be controlled concurrently or any of a possibility of variable intake cam timing, variable exhaust cam timing, dual independent variable cam timing or fixed cam timing may be used. In other embodiments, the intake and exhaust valves may be controlled by a common valve actuator or actuation system, or a variable valve timing actuator or actuation system. In the example embodiment of FIG. 1, the vehicle system further includes a controller 112. In one example, the controller 112 includes a computer control system. The controller 112 may further include computer readable storage media (not shown) including code for enabling on-board monitoring and control of rail vehicle operation. The controller 112, while overseeing control and management of the vehicle system 100, may be configured to receive signals from a variety of engine sensors in order to determine operating parameters and operating conditions, and correspondingly adjust various engine actuators to control operation of the rail vehicle 104. For example, the controller 112 may receive signals from various engine sensors including, but not limited to, engine speed, engine load, boost pressure, exhaust pressure, ambient pressure, exhaust temperature, engine coolant temperature (ECT) from temperature sensor 148 coupled to cooling sleeve 150, etc. Correspondingly, the controller 112 may control the vehicle system 100 by sending commands to various components such as traction motors, alternator, cylinder valves, throttle, etc.

In some embodiments, each cylinder of engine 106 may be configured with one or more fuel injectors for providing fuel thereto. As a non-limiting example, FIG. 1 shows the cylinder 108 is including a fuel injector 158. The fuel injector 158 is shown coupled directly to cylinder 108 for injecting fuel directly therein. In this manner, fuel injector 158 provides what is known as direct injection of a fuel into combustion cylinder 108. The fuel may be delivered to the fuel injector 158 from high-pressure fuel system 160 including a fuel tank, fuel pumps, and a fuel rail. In one example, the fuel is diesel fuel that is combusted in the engine through compression ignition. In other non-limiting embodiments, the second fuel may be gasoline, kerosene, biodiesel, or other petroleum distillates of similar density through compression ignition (and/or spark ignition).

In some embodiments, combustion chamber 108 may alternatively or additionally include a fuel injector arranged in intake passage 132 in a configuration that provides what is known as port injection of fuel into the intake port upstream of the combustion chamber 108.

FIG. 2 shows an example embodiment of a system 200 with an engine 202, such as engine 106 described above with reference to FIG. 1, having a plurality of donor cylinders 203 and a plurality of non-donor cylinders 204. In the example embodiment of FIG. 2, the engine 202 is a V-12 engine having twelve cylinders. In other examples, the engine may be a V-6, V-8, V-10, V-16, I-4, I-6, I-8, opposed 4, or another engine type.

In the example embodiment of FIG. 2, the donor cylinders 203 are depicted as a first group of cylinders comprising four cylinders (e.g., cylinders labeled 2, 5, 9, and 10 in FIG. 1). The non-donor cylinders 204 are depicted as a second group of cylinders comprising eight cylinders (e.g., cylinders labeled 1, 3, 4, 6, 7, 8, 11, and 12 in FIG. 1). In other embodiments, the engine may include at least one donor cylinder and at least one non-donor cylinder. For example, the engine may have six donor cylinders and six non-donor cylinders, or three donor cylinders and nine non-donor cylinders. It should be understood, the engine may have any desired numbers of donor cylinders and non-donor cylinders, with the number of donor cylinders typically lower than the number of non-donor cylinders.

As depicted in FIG. 2, the donor cylinders 203 are coupled to a first exhaust manifold 208 which is part of an exhaust gas recirculation (EGR) system 209. The first exhaust manifold 208 is coupled to the exhaust ports of the donor-cylinders. As such, in the present example, the donor cylinders 203 are coupled exclusively to the first exhaust manifold 208.

Exhaust gas from each of the donor cylinders 203 is routed through the EGR system 209 to an exhaust gas inlet 218 in the intake passage 206. Exhaust gas flowing from the donor cylinders to the intake passage 206 passes through an EGR cooler 216 to cool the exhaust gas before the exhaust gas returns to the intake passage. The EGR cooler 216 is in fluid communication with a liquid coolant or other coolant to cool the exhaust gases from the donor cylinders 203. In some embodiments, the liquid coolant may be the same coolant that flows through the cooling sleeve surrounding each cylinder, such as cooling sleeve 150 depicted in FIG. 1, for example.

In the example embodiment illustrated in FIG. 2, the non-donor cylinders 204 are coupled to a second exhaust manifold 210. The second exhaust manifold 210 is coupled to the exhaust ports of at least the non-donor-cylinders, but, in some examples, may be coupled to exhaust ports of the donor cylinders. For example, exhaust gas from one or more of the donor cylinders may be directed to the second exhaust manifold 210 via a valve such that an amount of EGR may be reduced as desired, for example. In the present example, the non-donor cylinders 204 are coupled exclusively to the second exhaust manifold 210. Exhaust gas from the non-donor cylinders 204 flows to an exhaust system 220. The exhaust system may include exhaust gas treatment devices, elements, and components, for example, a diesel oxidation catalyst, a particulate matter trap, hydrocarbon trap, an SCR catalyst, etc., as described above. Further, in the present example, exhaust gas from the non-donor cylinders 204 drives a turbine 214 of a turbocharger.

In embodiments in which the engine is a V-engine, the exhaust manifolds 208 and 210 may be inboard exhaust manifolds. For example, the exhaust ports of each of the cylinders are lined up on the inside of the V-shape. In other embodiments, the exhaust manifolds 208 and 210 may be outboard exhaust manifolds. For example, the exhaust ports of each of the cylinders are lined up on the outside of the V-shape.

As depicted in FIG. 2, the engine 202 is configured with a turbocharger including the exhaust turbine 214 arranged along the second exhaust manifold 210, and a compressor 212 arranged in the intake passage 206. The compressor 212 may be at least partially powered by the exhaust turbine 214 via a shaft (not shown). As shown in FIG. 2, the exhaust gas inlet 218 is downstream of the compressor 212 in the intake passage 206. The turbocharger increases air charge of ambient air drawn into the intake passage 206 in order to provide greater charge density during combustion to increase power output and/or engine-operating efficiency. While in this case a single turbocharger is included, the system may include multiple turbine and/or compressor stages.

Further, as shown in FIG. 2, at least two of the donor cylinders 203 may be positioned contiguously (e.g., immediately adjacent to one another) in an engine bank. As an example, engine 202 may be a V-engine with two engine banks. For example, cylinders 1-6 are disposed in one bank and cylinders 7-12 are disposed in the other bank. In the present example, donor cylinders 9 and 10 are contiguous. In such a configuration, a size of the first exhaust manifold 208 may be reduced, and therefore, a volume of space occupied by the first exhaust manifold 208 may be reduced, for example, as the donor cylinders are positioned adjacent each other. Thus, the engine may be positioned in a vehicle in which packaging space is limited, such as a locomotive, for example.

In a V-12 engine, such as depicted in FIGS. 2-5, the engine may have a cylinder firing order such as 1-7-5-11-3-9-6-12-2-8-4-10, for example, in which cylinder 1 fires first, cylinder 7 fires second, cylinder 5 fires third, and so on. In other examples, the cylinders may have a different firing order. The donor cylinders may be configured such that two donor cylinders do not fire contiguously (e.g., one immediately after another). For example, for any and every two donor cylinder firings, there is at least one donor cylinder firing in between them in the firing order. In this manner, fluctuation of the fraction of EGR mixed with the intake air over the engine cycle may be reduced.

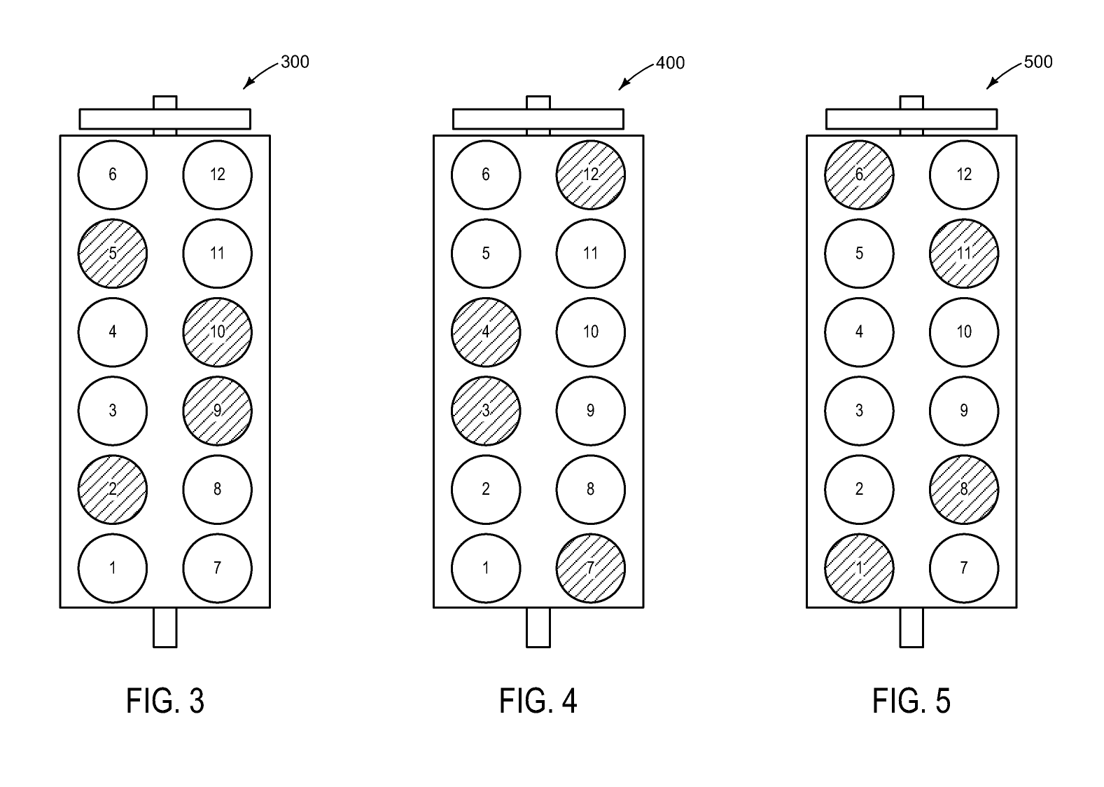

As an example, in the example embodiment shown in FIG. 3, the firing order of engine 300 may be 1-7-5D-11-3-9D-6-12-2D-8-4-10D, where the “D” indicates a donor cylinder. In the example embodiment shown in FIG. 4, the firing order of engine 400 may be 1-7D-5-11-3D-9-6-12D-2-8-4D-10. In the example embodiment shown in FIG. 5, the firing order of engine 500 may be 1D-7-5-11D-3-9-6D-12-2-8D-4-10. In each of the example firing orders described with reference to FIGS. 3-5, the donor cylinders do not fire one immediately after another. Instead, immediately between any and every two donor cylinder firings, there are two non-donor cylinder firings (e.g., 3D-9-6-12D in FIG. 4, 1D-7-5-11D in FIG. 5, etc.). In embodiments in which the engine includes three donor cylinders, the firing order may be 1D-7-5-11-3D-9-6-12-2D-8-4-10, 1-7D-5-11-3-9D-6-12-2-8D-4-10, 1-7-5D-11-3-9-6D-12-2-8-4D-10, or 1-7-5-11D-3-9-6-12D-2-8-4-10D, for example. In such examples, the engine operates with even firing of the donor cylinders. In this manner, the cylinders may receive a more even distribution of exhaust gas and intake air, for example. Further, engine noise, torque, and vibration (e.g., noise, vibration, and harshness (NVH)) characteristics may be improved.

In other embodiments, the engine may be configured with a number of donor cylinders such that each cylinder operates with a desired amount of exhaust gas during an engine cycle. In one example, the number of donor cylinders may be selected based on the desired amount of EGR, for example. In the embodiments of FIGS. 3-5, the engine may operate with ˜33% EGR in each cylinder (donor and non-donor). In other embodiments, the percentage of EGR each cylinder receives during the engine cycle may be 25%, 50%, or another desired amount, for example.

As depicted in the examples of FIGS. 3 and 4, at least two of the cylinders in the donor cylinder configuration are positioned immediately adjacent one another. In this manner, a space occupied by the exhaust manifold coupling the donor cylinders to the intake manifold may be reduced. Further, because the cylinders are fired with an even firing order, as described above, a fluctuation of a cylinder-to-cylinder distribution of exhaust gas in the intake air over an engine cycle may be decreased resulting in a more even distribution of exhaust gas between each of the cylinders.

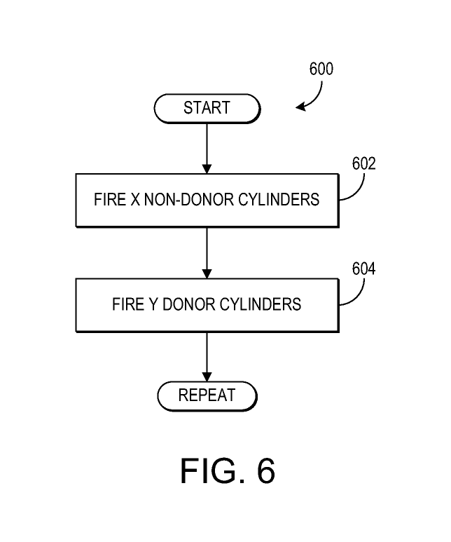

FIG. 6 shows a high level flow chart illustrating a method 600 for operating an engine with a plurality of donor cylinders and a plurality of non-donor cylinders, such as engines 202, 300, 400, 500, or 600 described above, such that the engine operates with a substantially even cylinder-to-cylinder distribution of EGR.

At 602 of method 600, X non-donor cylinders are fired. X may be any suitable number greater than or equal to one, for example, based on a number of cylinders in the engine and a desired EGR distribution. As an example, in the embodiment depicted in FIG. 3, as described above, two non-donor cylinders are fired contiguously. In another embodiment, three non-donor cylinders may be fired.

At 604 of method 600, Y donor cylinders are fired. Y may be any suitable number greater than or equal to one, for example, based on a number of cylinders in the engine and a desired EGR distribution. As an example, in the embodiment depicted in FIG. 3, as described above, one donor cylinder is fired.

After Y donor cylinders are fired, method 600 repeats such that every cylinder in the engine is fired during the engine cycle. In this manner, a cylinder-to-cylinder variation of intake EGR fraction may be reduced, thereby reducing NVH and torque imbalance.

In still other embodiments, the firing order over an engine cycle may be one donor cylinder immediately followed by two non-donor cylinders, immediately followed by one donor cylinder, immediately followed by one non-donor cylinder, for example.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method of operating an exhaust gas recirculation engine during an engine cycle, the engine having a plurality of exhaust gas donor cylinders and a plurality of non-donor cylinders, comprising:
firing each of the plurality of donor cylinders; and
firing at least one of the non-donor cylinders between every donor cylinder firing of the engine cycle.

2. The method of claim 1, wherein the plurality of donor cylinders are coupled exclusively to a first exhaust manifold and the plurality of non-donor cylinders are coupled exclusively to a second exhaust manifold.

3. The method of claim 2, wherein the first exhaust manifold is coupled to an intake passage of the engine downstream of a compressor of a turbocharger.

4. The method of claim 1, wherein firing at least one of the non-donor cylinders between every donor cylinder firing includes firing a number of at least one non-donor cylinders immediately between every donor cylinder firing of the engine cycle.

5. The method of claim 1, wherein firing at least one of the non-donor cylinders between every donor cylinder firing includes firing three non-donor cylinders immediately between every donor cylinder firing of the engine cycle.

6. The method of claim 1, wherein firing at least one of the non-donor cylinders between every donor cylinder firing includes firing one non-donor cylinder immediately between every donor cylinder firing of the engine cycle.

7. The method of claim 1, wherein the engine is positioned in a rail vehicle, a boat, or a ship.

8. The method of claim 1, wherein the engine is a V-8, V-12, V-16, or I-8 engine.

9. The method of claim 1, wherein at least two of the donor cylinders are contiguous in a bank of the engine.

10. A method of operating an engine, the engine having a plurality of donor cylinders and a plurality of non-donor cylinders, comprising:
firing each of the engine cylinders in a cylinder firing order, including firing at least one of the non-donor cylinders between any and every two donor cylinder firings in the cylinder firing order.

11. The method of claim 10, wherein the donor cylinders are fired with even spacing of time intervals in the firing order over an engine cycle.

12. The method of claim 11, wherein firing the donor cylinders with even spacing includes firing two non-donor cylinders immediately between every donor cylinder firing for every firing in the firing cylinder order.

13. The method of claim 10, wherein firing the donor cylinders with even spacing in the cylinder firing order includes firing three non-donor cylinders immediately between each donor cylinder firing for every firing in the cylinder firing order.

14. The method of claim 10, wherein firing the donor cylinders with even spacing in the cylinder firing order includes firing two non-donor cylinders immediately followed by one donor cylinder firing, immediately followed by one non-donor cylinder.

15. The method of claim 10, wherein at least two of the plurality of donor cylinders are disposed immediately adjacent to one another in an engine bank.

16. A system, comprising:
an engine having a first cylinder group including a plurality of non-donor cylinders and a second cylinder group including a plurality of donor cylinders, where at least two of the donor cylinders are contiguous on an engine bank;
a first exhaust manifold coupled to the first cylinder group;
an exhaust gas recirculation system including a second exhaust manifold coupled between the second cylinder group and an engine intake passage, and an exhaust gas recirculation cooler; and
a controller configured to operate the engine with even donor cylinder firing.

17. The system of claim 16, wherein even donor cylinder firing includes firing two non-donor cylinders immediately between every donor cylinder firing for every firing in a cylinder firing order.

18. The system of claim 16, wherein the engine intake passage includes an exhaust gas inlet downstream of a compressor of a turbocharger.

19. The system of claim 16, wherein the engine is a V-engine with two banks of cylinders and each of the two banks includes at least two donor cylinders and at least two non-donor cylinders, and wherein two donor cylinders are contiguous on at least one of the two banks.

20. The system of claim 16, wherein the engine is a four-stroke engine.
